(19) United States
(12) Patent Application Publication
(10) Pub. No.: US 2026/0109263 A1
(43) Pub. Date: Apr. 23, 2026

(54) ENERGY SUPPLY SYSTEM AND METHOD FOR OPERATING SUCH AN ENERGY SUPPLY SYSTEM

(71) Applicants: Eberspächer Controls Landau GmbH & Co. KG, Landau (DE); Eberspächer Controls Esslingen GmbH & Co. KG, Esslingen (DE)

(72) Inventors: Florian Suess, Weinstadt (DE); Fabian Brauss, Karlsruhe (DE)

(21) Appl. No.: 19/364,815

(22) Filed: Oct. 21, 2025

(30) Foreign Application Priority Data
Oct. 21, 2024 (DE) 10 2024 130 494.4
Nov. 21, 2024 (DE) 10 2024 134 165.3

(51) Int. Cl. B60L 58/16; B60L 50/40; B60L 50/61

(52) U.S. Cl. CPC B60L 58/16; B60L 50/40; B60L 50/61; B60L 2210/12; B60L 2210/14; B60L 2240/547

(57) ABSTRACT

An energy supply system, in particular for a vehicle, includes an energy storage device having at least one supercapacitor arrangement, a consumer/generator arrangement for taking up energy from the energy storage device and for providing energy that is to be stored in the energy storage device, a charging/discharging unit for conducting energy from the consumer/generator arrangement to the energy storage device in a charging operating state, and an actuation unit for actuating the charging/discharging unit. The actuation unit is configured to actuate the charging/discharging unit to charge the at least one supercapacitor arrangement to a target storage voltage in the charging operating state, wherein the target storage voltage increases as the at least one supercapacitor arrangement ages.

### CROSS-REFERENCE TO RELATED APPLICATIONS

This application claims priority of German patent application nos. 10 2024 130 494.4, filed Oct. 21, 2024, and 10 2024 134 165.3, filed Nov. 21, 2024, the entire contents of which are incorporated herein by reference.

### TECHNICAL FIELD

The present disclosure relates to an energy supply system which can be used, for example, to feed electrical energy to consumers in a vehicle. The disclosure further relates to a method for operating such an energy supply system.

### BACKGROUND

Electrically operated vehicles and also vehicles driven by internal combustion engines or hybrid systems have an increasing number of consumers of electrical energy which are fed via an on-board voltage network from an energy storage device present in a vehicle. Such an energy storage device may include one or more batteries which can store and provide the energy required for driving electric traction motors, especially in electrically powered vehicles, too. As an alternative or in addition, such energy storage devices may include supercapacitor (SCAP) arrangements which, for example, are constructed from a plurality of supercapacitors (SCAPs) connected to one another in series, are capable of very quickly taking up energy released, for example, during braking operations and likewise delivering energy very quickly. Such supercapacitor arrangements are therefore particularly suitable for providing electrical energy for short-term support processes, for example for supporting an electric steering system or for feeding or supporting the feeding of electric traction motors during strong acceleration processes.

### SUMMARY

It is an object of the present disclosure to provide an energy supply system, in particular for a vehicle, and a method for operating such an energy supply system, using which excessive ageing of a supercapacitor arrangement contained in an energy supply system can be counteracted and thus a maximum service life thereof can be increased.

According to a first aspect of the present disclosure, this object is achieved by an energy supply system, in particular for a vehicle, including:
an energy storage device having at least one supercapacitor arrangement,
a consumer/generator arrangement for taking up energy from the energy storage device and for providing energy that is to be stored in the energy storage device,
a charging/discharging unit for conducting energy from the consumer/generator arrangement to the energy storage device in a charging operating state,
an actuation unit for actuating the charging/discharging unit.

The actuation unit of the energy supply system constructed according to the disclosure is configured to actuate the charging/discharging unit to charge the at least one supercapacitor arrangement to a target storage voltage in the charging operating state, wherein the target storage voltage increases as the at least one supercapacitor arrangement ages.

The ageing of supercapacitor arrangements or supercapacitors contained therein is essentially determined by the voltage applied to them or the temperature at which they are operated. Operating under unfavorable temperature conditions and especially charging to relatively high voltages facilitate rapid ageing of supercapacitors. Since the energy supply system according to the disclosure ensures that the target storage voltage, that is, the storage voltage, to which the supercapacitor arrangement is charged at a maximum in a charging operating state, increases as it ages, it is possible to operate using a comparatively small target storage voltage over a comparatively long period of the service life of such a supercapacitor arrangement, which results in lower ageing of the supercapacitor arrangement. Since, in conjunction with the ageing and the thus inevitable degradation of the performance of the supercapacitor arrangement, the target storage voltage is increased, it is ensured that, even after a longer service life, in a support process, that is, when providing electrical energy from the supercapacitor arrangement, the electrical power required for operating the consumer/generator arrangement can be maintained over a period of time generally required or requested for a support process.

To operate one or more consumers of electrical energy at a defined operating voltage, the charging/discharging unit may be provided to conduct energy from the energy storage device in the consumer/generator arrangement in an infeed operating state.

In order to ensure that, during a support operation, that is, when feeding electrical energy from the at least one supercapacitor arrangement, the fed system, that is, the consumer/generator arrangement, can be operated in a defined operating state, in particular at the defined electrical voltage, it is proposed that the actuation unit is configured to actuate the charging/discharging unit in the infeed operating state to provide a target operating voltage for the consumer/generator arrangement.

For this purpose, the charging/discharging unit may include, for example, a DC/DC (direct current/direct current) converter.

In order to avoid excessively large dimensioning of the at least one supercapacitor arrangement, but nevertheless also be able to supply the consumer/generator arrangement in a state of high load with the required electrical voltage, the actuation unit may be configured to operate the charging/discharging unit as a step-up converter in the infeed operating state or/and operate the charging/discharging unit as a step-down converter in the charging operating state.

Depending on the configuration or dimensioning of the at least one supercapacitor arrangement, the actuation unit may alternatively or additionally be configured to operate the charging/discharging unit as a step-down converter in the infeed operating state or/and to operate the charging/discharging unit as a step-up converter in the charging operating state.

In order to be able to ensure that such a supercapacitor arrangement is sufficiently charged in the charging mode over the service life of an energy supply system or a supercapacitor arrangement contained therein, but is not unnecessarily significantly charged, the actuation unit may be configured to determine the target storage voltage on the basis of state of health information representing a state of health of the at least one supercapacitor arrangement.

For example, the state of health information may include service life information representing a service life of the at least one supercapacitor arrangement. Such service life information may be represented, for example, by the time period since the initial commissioning of the energy supply system or the supercapacitor arrangement, by the sum of the time periods in which, for example, a vehicle containing such an energy supply system was in operation or also the number of previously executed charging or discharging processes or combinations of these variables.

In a configuration that takes the actual ageing into account even more precisely, the state of health information may include operating parameter information representing at least one operating parameter of the at least one supercapacitor arrangement.

For example, the operating parameter information may include:
information relating to an internal resistance of the at least one supercapacitor arrangement,
or/and
information relating to a capacitance of the at least one supercapacitor arrangement.

Each of these parameters is associated with the ageing and therefore the service life of such a supercapacitor arrangement. An increasing internal resistance with decreasing capacitance of a supercapacitor arrangement or individual supercapacitors of such an arrangement is a major factor in the energy that is released or that can be released during a discharge process decreasing as ageing increases.

To determine such operating parameters, an operating parameter determination arrangement can be provided to determine at least one operating parameter dependent on a state of health of the at least one supercapacitor arrangement.

The operating parameter determination arrangement may be configured, for example, to determine the capacitance of the at least one supercapacitor arrangement using known measurement methods or/and to determine an internal resistance of the at least one supercapacitor arrangement using known measurement methods, preferably based on an ESR resistance value.

In order to ensure, in particular also in older energy supply systems or supercapacitor arrangements thereof, that the target storage voltage gradually increased over the service life does not shift in the range of the decomposition voltage of the supercapacitor arrangement or the supercapacitors thereof, it is proposed that the actuation unit is configured to increase the target storage voltage up to a maximum target storage voltage, and that a rated voltage of the at least one supercapacitor arrangement is greater than or equal to the maximum target storage voltage. Supercapacitors are configured in principle in such a way that the rated voltage thereof has a sufficient safety interval from the decomposition voltage, so that increasing the target storage voltage to the range of rated voltage also cannot trigger a voltage-related decomposition process in the supercapacitors.

To provide a sufficiently high storage capacity or a sufficiently high rated voltage of a supercapacitor arrangement, the at least one supercapacitor arrangement may include a plurality of supercapacitors connected to one another in series or/and a plurality of supercapacitors connected to one another in parallel. It should be noted that, in the case of a series connection of multiple supercapacitors, the rated voltages of the individual supercapacitors add up to the rated voltage of the entire supercapacitor arrangement, since, especially when using identical supercapacitors in a supercapacitor arrangement, essentially the same voltage drops across each of the supercapacitors. When such supercapacitors are connected in parallel, the energy storage capacity of the supercapacitor arrangement is increased at the rated voltage of the supercapacitor arrangement which is not increased in principle by the number of supercapacitors connected in parallel.

It should be noted that such supercapacitors, also referred to as ultracapacitors, for example connected in parallel or/and series to form a supercapacitor arrangement, may be configured as double-layer capacitors, pseudo-capacitors or hybrid capacitors, for example. It is also possible to use multiple supercapacitor arrangements connected in series or/and multiple connected in parallel, each including one or more supercapacitors of one or more of the aforementioned types, for the energy storage device of the energy supply system according to the disclosure.

The consumer/generator arrangement may include at least one generator and at least one consumer. For example, one or more separate electric traction motors can be used as a generator in the charging mode in an electric motor-operated vehicle with wheels individually driven by the electric traction motors. Likewise, any such electric traction motor can be fed from the energy storage device as a consumer of electrical energy.

The consumer/generator arrangement may include at least one consumer fed in the infeed operating state via the charging/discharging unit with energy from the energy storage device. Such consumers fed via the charging/discharging unit with energy from the energy storage device, in particular the at least one supercapacitor arrangement, are, for example, consumers of electrical energy which are to be operated for correct operation at a defined voltage or a voltage in a defined, comparatively narrow voltage range.

As an alternative or in addition, the consumer/generator arrangement may include at least one consumer not supplied with energy from the energy storage device via the charging/discharging unit. Such consumers which are not fed via the charging/discharging unit, but for example directly from the energy storage device or the at least one supercapacitor arrangement, are, for example, consumers of electrical energy, for the correct operation of which a minimum voltage must be provided, but which in principle can also be operated at higher voltages, in particular the maximum voltage that can be provided by the energy storage device or the at least one supercapacitor arrangement.

According to a further aspect, the object mentioned at the outset is achieved by a method for operating an energy supply system constructed according to the disclosure, in particular in a vehicle, in which method the target storage voltage of the at least one supercapacitor arrangement is determined in such a way that the target storage voltage increases as the at least one supercapacitor arrangement ages.

In order to ensure, at all times, over the service life of a supercapacitor arrangement used in an energy storage system that the supercapacitor arrangement is sufficiently but not unnecessarily significantly charged, provision may be made for the target storage voltage to be increased from a minimum target storage voltage assigned to a minimum state of health of the at least one supercapacitor arrangement to a maximum target storage voltage assigned to a maximum state of health of the at least one supercapacitor arrangement.

The increasing of the target storage voltage up to a range in which there is a risk of decomposition in the interior of a supercapacitor can be prevented by the fact that the maximum target storage voltage is less than or equal to a rated voltage of the at least one supercapacitor arrangement.

### BRIEF DESCRIPTION OF DRAWINGS

The invention will now be described with reference to the drawings wherein:

FIG. 1 shows an illustration of an energy supply system in a vehicle;

FIG. 2 shows a relationship between a state of health of a supercapacitor arrangement and a target storage voltage that changes as a function of the state of health;

FIG. 3 shows a representation corresponding to FIG. 1 of an alternatively configured energy supply system; and,

FIG. 4 shows a further representation corresponding to FIG. 1 of an alternatively configured energy supply system.

### DETAILED DESCRIPTION

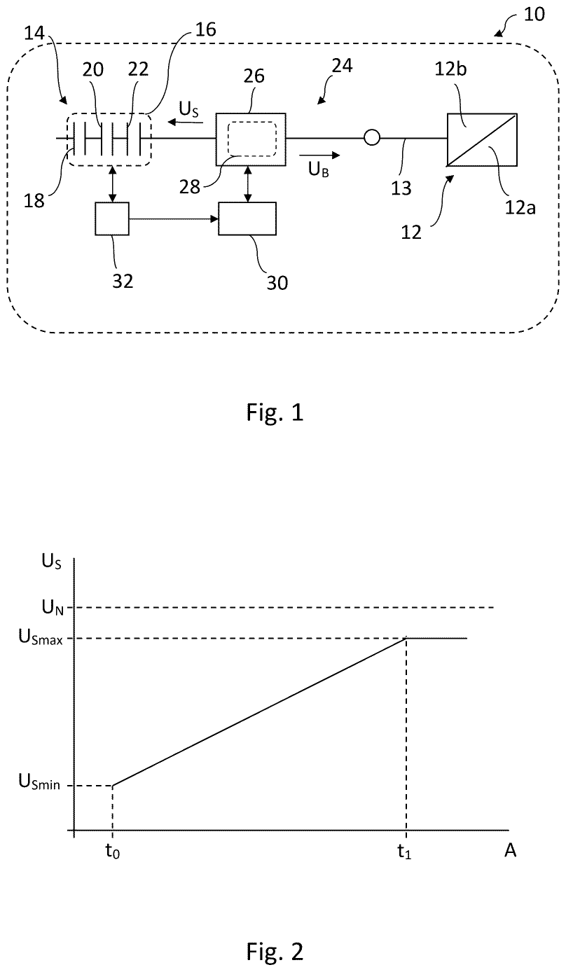

In FIG. 1, a vehicle is generally designated by 10. The vehicle 10 may be an electric motor-driven vehicle, but may also be a vehicle driven by an internal combustion engine or by a hybrid drive system. In the vehicle 10, a consumer/generator arrangement is generally designated by 12, including a plurality of consumers 12b of electrical energy and also one or more generators 12a for providing electrical energy, for example in a braking operation. The consumer/generator arrangement 12 may include an on-board voltage network 13, via which the consumers 12b are fed with electrical energy or from which electrical energy generated by the generator or generators 12a can be fed into an energy storage device, generally denoted by 14.

The energy storage device 14 shown in FIG. 1 includes a supercapacitor arrangement 16 which in turn may include a plurality of supercapacitors 18, 20, 22 connected to one another in series. It must be emphasized that the number of the supercapacitors connected to one another in series can be selected as a function of the energy to be stored in the supercapacitor arrangement 16 and in particular also as a function of a rated voltage of the supercapacitor arrangement 16 specified for such an energy supply system 24 of the vehicle 10. Depending on the required energy storage capacity, the supercapacitor arrangement 16 may alternatively or additionally include supercapacitors connected to one another in parallel. In principle, the energy storage device 14 may also include multiple supercapacitor arrangements 16 connected to one another in parallel or/and multiple supercapacitor arrangements 16 connected to one another in series.

In particular, if the vehicle 10 is configured as an electric motor-driven vehicle or as a hybrid vehicle, the energy storage device 14 may include, in addition to the supercapacitor arrangement 16, one or more batteries, of which at least one can be used as a traction battery for storing or delivering the electrical energy required for operating electric traction motors.

In the vehicle 10, the supercapacitor arrangement 16 serves primarily to provide the required energy in an infeed operating state in a comparatively short time in states of high energy demand, for example when an electrically driven vehicle is to be strongly accelerated or steering operations are to be carried out in an electrically operated steering system. Likewise, in briefly occurring states in which energy is released, that is, for example during braking interventions, the supercapacitor arrangement 16 in a charging operating state can take up and store energy from the consumer/generator arrangement 12 or the on-board voltage network 13.

The flow of energy between the supercapacitor arrangement 16 and the consumer/generator arrangement 12 is regulated by a charging/discharging unit 26. The charging/discharging unit 26 may include a DC/DC converter 28 which is under the actuation of an actuation unit 30 in the manner described below and ensures that, in the infeed operating state, a predetermined or suitable target operating voltage UB is provided for the operation of the consumers of electrical energy in the consumer/generator/arrangement 12 or that the supercapacitor arrangement 16 is charged to a target storage voltage U_{S} in the charging operating state.

Taking into account the fact that the performance of the supercapacitors 18, 20, 22 decreases over the service life of such a supercapacitor arrangement 16 or the supercapacitors 18, 20, 22 thereof, this generally resulting in the energy that can be released in an infeed operating state also decreasing, the rated voltage of the supercapacitor arrangement 16 in the new state thereof is configured so that it is larger than would be required in principle taking into account the operating characteristics of the DC/DC converter. This means that the supercapacitor arrangement 16 is fundamentally overdimensioned for the new state of the supercapacitor arrangement 16 or the vehicle 10 including same. As a result of this overdimensioning of the supercapacitor arrangement 16 and taking into account the fact that the DC/DC converter is operated as a step-up converter in the infeed operating state, the supercapacitor arrangement 16 can therefore be charged in the charging operating state to a comparatively low target storage voltage U_{S} predetermined by the actuation unit 30.

Since the internal resistance of the supercapacitor assembly 16 or the individual supercapacitors 18, 20, 22 thereof is comparatively low and the capacitance of the supercapacitors 18, 20, 22 and thus the total capacitance of the supercapacitor assembly 16 is comparatively high in a new state, sufficient power can be provided over an equally sufficient period of time at a comparatively low target storage voltage U_{S} even when electrical energy is to be fed into the consumer/generator arrangement 12 in the infeed operating state.

Since the voltage of the supercapacitor arrangement 16 drops during such an infeed operation, the DC/DC converter 28 is controlled such that the target operating voltage UB provided for the operation of the consumer/generator arrangement 12 is provided at the output thereof so as to be substantially constant.

After the complete or partial discharge of the supercapacitor arrangement 16, the DC/DC converter 28 is operated in the charging operating state under the actuation of the actuation arrangement 30 in such a way that the charging voltage applied to the supercapacitor arrangement 16 essentially corresponds to the target storage voltage U_{S} or the charging process proceeds in such a way that the target storage voltage U_{S} of the supercapacitor arrangement 16 is reached.

As illustrated in FIG. 2, accompanied by the unavoidable decrease in the performance of the supercapacitor arrangement 16 over the service life, the DC/DC converter 28 is operated via the actuation unit 30 in such a way that, in the case of repeated charging operating states over the service life, the target storage voltage U_{S} gradually increases, for example starting from a minimum target storage voltage U_{Smin} provided for a new state of the supercapacitor arrangement 16 or the vehicle 10 represented by the time t₀. A higher target storage voltage U_{S} can be used to compensate for a decrease in the capacitance of the supercapacitor arrangement 16 or increase in the internal resistance of the supercapacitor arrangement 16 or the individual supercapacitors 18, 20, 22 thereof over the service life so that, by charging the supercapacitor arrangement 16 to a higher target storage voltage U_{S} in a subsequent infeed operating state, the DC/DC converter 28, starting from a higher target storage voltage U_{S} of the supercapacitor arrangement 16, can regulate the target operating voltage U_{B} to be provided for the consumer/generator arrangement 12 and can maintain it for the required time. In this way, it is possible to compensate for the power loss arising from the higher internal resistance and the capacitance that decreases as the supercapacitor arrangement 16 ages.

This compensation achieved by increasing the target storage voltage U_{S} can be carried out until, at a time t₁ corresponding to a state of maximum ageing of the supercapacitor arrangement 16, the target storage voltage U_{S} is in the range of a maximum target storage voltage U_{Smax} at or below a rated voltage U_{N} of the supercapacitor arrangement 16. The rated voltage U_{N} of the supercapacitor assembly 16, which is essentially composed of the rated voltages of the supercapacitors 18, 20, 22 thereof, should not be exceeded to ensure that a decomposition voltage, at which a decomposition of the electrolyte provided in such supercapacitors occurs, is not reached.

The energy supply system 24 or the supercapacitor arrangement 16 should be configured such that the time t₁ is after the expected maximum service life of, for example, the vehicle 10. In principle, even after the time t₁ has been reached, the energy storage system 24 can still be operated, for example in such a way that the target storage voltage U_{S} is no longer increased from the time t₁. This can prevent the rated voltage U_{N} being exceeded or a decomposition voltage being reached. However, losses in the performance of the supercapacitor arrangement 16 must be accepted.

In order to adapt the increase of the target storage voltage that is to be carried out over the service life to the state of health of the supercapacitor arrangement 16, state of health information representing the state of health A of the supercapacitor arrangement 16 can be used in the actuation unit 30 to predetermine the level of the target storage voltage depending on this information and to accordingly actuate the DC/DC converter 28 in the charging operating state. In a very simply configured procedure, for example, the period of time since the first commissioning of the supercapacitor arrangement 16 can be used as such state of health information in the actuation unit 30. In the graph in FIG. 2, this means that the state of health A represents a time axis on which the time t₀ corresponds to the new state and the time t₁ represents a time from which the target storage voltage U_{S} is no longer increased even with the supercapacitor arrangement 16 still in operation. Alternatively, the sum of the time periods during which the vehicle 10 or the supercapacitor arrangement 16 was in operation can be used as information representing the state of health A. The number of charging or discharging cycles carried out can also be used as an indicator of the state of health A.

The state of health A can be considered more precisely in that the supercapacitor arrangement 16 is assigned an operating parameter determination arrangement 32. This operating parameter determination arrangement, as a separate assembly or, for example, also in a manner integrated into the actuation unit 30, can determine the capacitance of the supercapacitor arrangement 16 or the individual supercapacitors 18, 20, 22, for example using known measuring methods. Furthermore, the operating parameter determination arrangement 32 can detect or determine the inner resistance of the supercapacitor arrangement 16 or of the individual supercapacitors 18, 20, 22 that substantially determines the internal power losses of the supercapacitor arrangement 16. For this purpose, for example, the ESR resistance value representing an AC resistance can be determined and converted to the DC internal resistance using known correlation factors.

Since the internal resistance increases and the capacitance decreases with increasing age, that is, as the service life of the supercapacitor arrangement 16 increases, the state of health A can be precisely inferred on the basis of these operating parameters and, based on this operating parameter information, the target storage voltage U_{S} for the supercapacitor arrangement 16 is predetermined by the actuation unit 30 and, accordingly, in the charging operating state, the DC/DC converter 28 can be actuated to charge the supercapacitor arrangement 16 to the respective target storage voltage U_{S}.

The preceding text has described such operation of the energy supply system 24 in which the target storage voltage U_{S} is basically smaller than the target operating voltage UB of the consumers 12b fed with electrical energy via the charging/discharging unit 26. The energy supply system 24 or the at least one supercapacitor arrangement 16 could also be configured such that the target storage voltage U_{S} is higher or at least in phases is higher than the target operating voltage UB.

If the at least one supercapacitor arrangement 16 is charged to a storage voltage above the target operating voltage UB and, for example, in the range of the target storage voltage U_{S} in such an energy supply system 24, in an infeed operating state to then be carried out the actuation unit 30 can actuate or operate the charging/discharging unit 26 or the DC/DC converter 28 thereof in such a way that the voltage undergoes a step-down conversion, the DC/DC converter 28 is thus operated as a step-down converter.

If it is ensured that, in such an energy supply system 24, a state in which the storage voltage of the at least one supercapacitor arrangement 16 falls below the rated operating voltage UB does not occur and a state in which a charging voltage generated by the consumer/generator arrangement 12 is fundamentally lower than a minimum storage voltage of the supercapacitor arrangement 16, the DC/DC converter 28 can be configured in principle in such a way that it can only be operated as a step-down converter in the infeed operating state and can only be operated as a step-up converter in the charging operating state.

If operating states in which, for example, in the infeed operating state the storage voltage of the at least one supercapacitor arrangement 16 initially above the target operating voltage UB falls below the target operating voltage UB when the same is discharged progressively can occur in the energy supply system 24, for example in the configuration of the DC/DC converter as a four-quadrant converter, the actuation unit 30 can actuate the DC/DC converter 28 in such a way that it operates as a step-down converter in a phase in which the storage voltage of the at least one supercapacitor arrangement 16 is above the target operating voltage UB, and as a boost converter when the storage voltage of the at least one supercapacitor arrangement 16 falls below the target operating voltage UB. In this way, it is possible to ensure, irrespective of the state of charge of the at least one supercapacitor arrangement 16 or the storage voltage thereof, that an operating voltage at a defined level, that is, the target operating voltage UB, can be provided for the on-board power supply 13 or the consumers 12b.

Likewise, in such a configuration of the DC/DC converter 28, provision can be made, when the target storage voltage U_{S} is above the charging voltage provided by the consumer/generator arrangement 12 or, for example, the maximum available charging voltage, in a phase in which, for example, in a significantly discharged supercapacitor arrangement 16, the charging voltage generated by the consumer/generator arrangement 12 is above the storage voltage of the at least one supercapacitor arrangement 16, for the DC/DC converter 28 to be operated as a step-down converter and, when the storage voltage of the at least one supercapacitor arrangement 16 reaches the charging voltage as it is increasingly charged, for the DC/DC converter 28 to be operated as a boost converter in order to charge the at least one supercapacitor arrangement 16 to a target storage voltage U_{S} above the charging voltage.

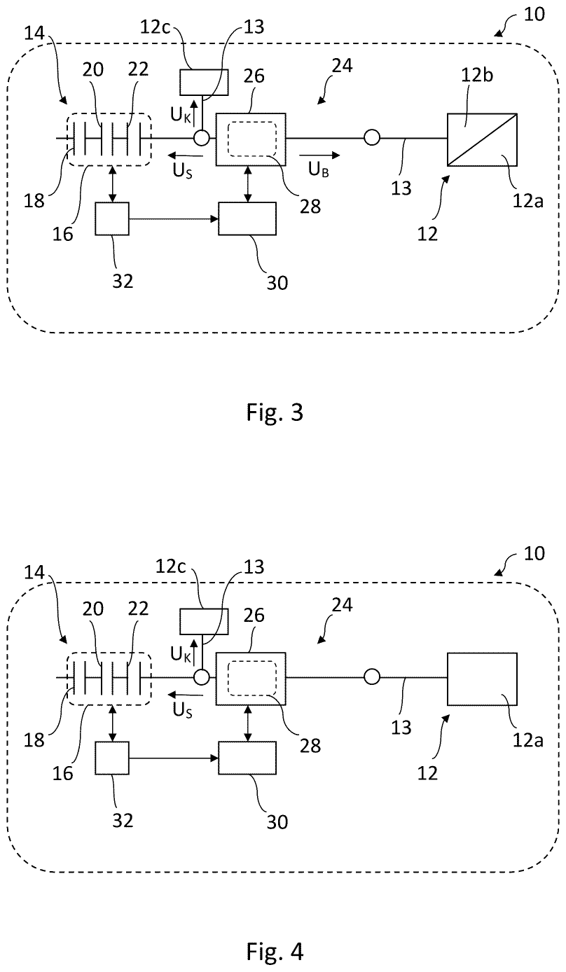

FIG. 3 shows a variation of the vehicle 10 or energy supply system 24 illustrated in FIG. 1. In this configuration of the energy supply system 24, the consumer/generator arrangement 12 includes the consumers 12b of the on-board voltage network 13 that are to be supplied with electrical energy via the charging/discharging unit 26. These are, for example, such consumers for the operation of which an operating voltage to be generated by the charging/discharging arrangement 26 or the DC/DC converter 28 is required. In addition, the consumer/generator arrangement 12 includes consumers 12c which, for example also combined via the or a part of the on-board power supply 13, are not necessarily to be operated at a defined operating voltage or an operating voltage in a comparatively narrow range, but for which, for example, a minimum operating voltage is predetermined, but which in principle can also be operated at higher voltages.

These consumers 12c are not coupled to the energy storage device 14 or the at least one supercapacitor arrangement 16 via the charging/discharging arrangement 26. Instead, these consumers 12c or the part of the on-board power supply 13 including same are coupled, for example, essentially directly to the energy storage device 14 or the at least one supercapacitor arrangement 16 while bypassing the charging/discharging arrangement 26 and are therefore fed therefrom substantially directly and without converting the voltage level.

This means that the operating voltage U_{K} available for these consumers 12c or applied thereto essentially corresponds to the storage voltage thereof that is dependent on the state of charge of the at least one supercapacitor arrangement 60. If the at least one supercapacitor arrangement 16 is charged to the target storage voltage U_{S}, the operating voltage U_{K} available for the consumers 12c or applied thereto essentially corresponds to the target storage voltage U_{S}. As the storage voltage decreases, the operating voltage U_{K} also drops.

In order to ensure in such a configuration of the energy supply system 24 that these consumers 12c which are not fed via the charging/discharging arrangement 26 can also be operated reliably, for example, provision may be made, when the storage voltage of the at least one supercapacitor arrangement 16 falls below the minimum operating voltage predetermined for the operation of the consumers 12c, for the actuation unit 30 to feed these consumers 12c from another source, for example a battery of the energy storage device 14.

Another alternative configuration of the first vehicle 10 or the energy supply system 24 is illustrated in FIG. 4. In this embodiment, all consumers 12c of the consumer/generator arrangement 12 are integrated in the on-board voltage network 13 such that they are not fed via the charging/discharging unit 26. The charging/discharging unit 26 is used in this configuration exclusively for charging the at least one supercapacitor arrangement 16 on the basis of the charging voltage generated by the generator(s) 12a to a defined target storage voltage U_{S}. All consumers of electrical energy are grouped together in one part of the on-board power supply 13 which, for example, is essentially directly coupled to the energy storage device 14 or to the at least one supercapacitor arrangement 16 and therefore, in the infeed operating state, the operating voltage U_{K} essentially corresponding to the storage voltage of the at least one supercapacitor arrangement 16 is applied thereto.

Using the energy supply system 24 configured according to the disclosure or the method for operating same described above, it is possible to increase the service life of a supercapacitor arrangement, since for the majority of its service life this is operated at voltages or charged to storage voltages which are comparatively low in relation to the rated voltage. This results in lower or slower ageing of such a supercapacitor arrangement. At the same time, even after a longer service life, that is, in a comparatively significantly aged supercapacitor arrangement, at a then already significantly increased target storage voltage using the DC/DC converter in infeed operating states, the target operating voltage required for the system to be fed can be provided over a required or predetermined time period for such a support operation.

Since the target storage voltage can be kept significantly below the rated voltage for the majority of the service life by the targeted control intervention during the execution of the charging operating states, it is therefore not necessary, for example, for an excessively large number of individual supercapacitors to be provided in order to achieve a lower load on the supercapacitor arrangement or the individual supercapacitors thereof, thereby reducing the voltage drop across each of the individual supercapacitors. Using the energy supply system according to the disclosure or the method for operating same, it is thus not only possible to increase the service life via intelligent actuation, but also to achieve this even with a comparatively small number of supercapacitors used in a supercapacitor arrangement.

It is understood that the foregoing description is that of the preferred embodiments of the invention and that various changes and modifications may be made thereto without departing from the spirit and scope of the invention as defined in the appended claims.

1. An energy supply system comprising:
an energy storage device having at least one supercapacitor arrangement;
a consumer/generator arrangement configured to receive energy from said energy storage device and to provide energy to be stored in said energy storage device;
a charging/discharging unit for conducting energy from said consumer/generator arrangement to said energy storage device in a charging operating state;
an actuation unit for actuating said charging/discharging unit; and,
said actuation unit being configured to actuate the charging/discharging unit to charge said at least one supercapacitor arrangement to a target storage voltage in said charging operating state, wherein said target storage voltage increases as said at least one supercapacitor arrangement ages.

2. The energy supply system of claim 1, wherein said charging/discharging unit is provided to conduct energy from said energy storage device to said consumer/generator arrangement in an infeed operating state.

3. The energy supply system of claim 2, wherein said actuation unit is configured to actuate said charging/discharging unit to provide a target operating voltage for said consumer/generator arrangement in said infeed operating state.

4. The energy supply system of claim 1, wherein said charging/discharging unit includes a DC/DC converter.

5. The energy supply system of claim 4, wherein at least one of:
said actuation unit is configured to at least one of operate said charging/discharging unit as a step-up converter in said infeed operating state and operate the charging/discharging unit as a step-down converter in the charging operating state; and,
said actuation unit is configured to at least one of operate said charging/discharging unit as a step-down converter in the infeed operating state and operate said charging/discharging unit as a step-up converter in the charging operating state.

6. The energy supply system of claim 1, wherein said actuation unit is configured to determine said target storage voltage on a basis of state of health information representing a state of health of said at least one supercapacitor arrangement.

7. The energy supply system of claim 6, wherein the state of health information includes service life information representing a service life of said at least one supercapacitor arrangement.

8. The energy supply system of claim 6, wherein the state of health information includes operating parameter information representing at least one operating parameter of said at least one supercapacitor arrangement.

9. The energy supply system of claim 8, wherein said operating parameter information includes at least one of:
information relating to an internal resistance of the at least one supercapacitor arrangement; and,
information relating to a capacitance of the at least one supercapacitor arrangement.

10. The energy supply system of claim 8 further comprising an operating parameter determination arrangement configured to determine at least one operating parameter dependent on the state of health of said at least one supercapacitor arrangement.

11. The energy supply system of claim 9 further comprising:
an operating parameter determination arrangement configured to determine at least one operating parameter dependent on the state of health of said at least one supercapacitor arrangement; and,
said operating parameter determination arrangement being configured to determine at least one of the capacitance of said at least one supercapacitor arrangement and an internal resistance of said at least one supercapacitor arrangement.

12. The energy supply system of claim 9 further comprising:
an operating parameter determination arrangement configured to determine at least one operating parameter dependent on the state of health of said at least one supercapacitor arrangement; and,
said operating parameter determination arrangement is configured to determine at least one of the capacitance of said at least one supercapacitor arrangement and an internal resistance of said at least one supercapacitor arrangement on a basis of an ESR resistance value.

13. The energy supply system of claim 1, wherein said actuation unit is configured to increase said target storage voltage up to a maximum target storage voltage; and, a rated voltage of said at least one supercapacitor arrangement is greater than or equal to said maximum target storage voltage.

14. The energy supply system of claim 1, wherein said at least one supercapacitor arrangement includes at least one of a first plurality of supercapacitors connected to one another in series and a second plurality of supercapacitors connected to one another in parallel.

15. The energy supply system of claim 1, wherein said consumer/generator arrangement includes at least one generator and at least one consumer.

16. The energy supply system of claim 15, wherein:
said charging/discharging unit is provided to conduct energy from said energy storage device to said consumer/generator arrangement in an infeed operating state;
wherein at least one of:
said consumer/generator arrangement includes at least one consumer fed with energy from said energy storage device in said infeed operating state via said charging/discharging unit; and,
said consumer/generator arrangement includes at least one consumer not fed with energy from said energy storage device via said charging/discharging unit.

17. The energy supply system of claim 1, wherein the energy supply system is for a vehicle.

18. A method for operating an energy supply system including an energy storage device having at least one supercapacitor arrangement; the energy supply system further including a consumer/generator arrangement configured to receive energy from the energy storage device and to provide energy to be stored in the energy storage device; the energy supply system further including a charging/discharging unit for conducting energy from the consumer/generator arrangement to the energy storage device in a charging operating state; the energy supply system further including an actuation unit for actuating the charging/discharging unit, the actuation unit being configured to actuate the charging/discharging unit to charge the at least one supercapacitor arrangement to a target storage voltage in the charging operating state, wherein the target storage voltage increases as the at least one supercapacitor arrangement ages, the method comprising:
determining the target storage voltage of the at least one supercapacitor arrangement such that the target storage voltage increases as the at least one supercapacitor arrangement ages.

19. The method of claim 18, wherein the target storage voltage is increased from a minimum target storage voltage assigned to a minimum state of health of the at least one supercapacitor arrangement to a maximum target storage voltage assigned to a maximum state of health of the at least one supercapacitor arrangement.

20. The method according to claim 19, wherein the maximum target storage voltage is less than or equal to a rated voltage of the at least one supercapacitor arrangement.
